(19) United States
(12) Patent Application Publication
(10) Pub. No.: US 2006/0023777 A1
(43) Pub. Date: Feb. 2, 2006

(54) Signal transmission

(76) Inventors: Frank Oeser, Hermsdorf (DE); Harald Adolph, Balzhausen (DE); Roland Biber, Kinsau (DE)

Correspondence Address: GIFFORD, KRASS, GROH, SPRINKLE & CITKOWSKI, P.C, PO BOX 7021, TROY, MI, 48007-7021, US

(21) Appl. No.: 11/170,050

(22) Filed: Jun. 29, 2005

(30) Foreign Application Priority Data
Jul. 1, 2004 (DE) 10 2004 032 022.5

(51) Int. Cl. H04L 5/16

(52) U.S. Cl. 375/219

(57) ABSTRACT

The invention relates to a system for contact-free signal transmission and energy transmission comprising a transmitter apparatus for the transmission of a digital signal which includes at least one measurement signal generated by means of a measuring device, in particular a measurement signal digitized by means of an A/D converter unit of the transmitter apparatus, and a receiver apparatus for the reception of the transmitted digital signal, with the transmitter apparatus being movable, in particular rotatably movable, relative to the receiver apparatus and energy being able to be transmitted from the receiver apparatus to the transmitter apparatus for the energy supply of the transmitter apparatus and/or of the measuring device. The invention further relates to a corresponding method.

### RELATED APPLICATION

This application claims priority of German Patent Application No. 10 2004 032 022.5 filed Jul. 1, 2004.

### FIELD OF THE INVENTION

The invention relates to a system for signal transmission between a transmitter apparatus and a receiver apparatus, with the transmitter apparatus being movable relative to the receiver apparatus. The invention further relates to a corresponding method.

### BACKGROUND OF THE INVENTION

Systems and methods of this kind for signal transmission between a transmitter apparatus and a receiver apparatus are generally known. In these known systems and methods, the transmitter apparatus, which is movable relative to the receiver apparatus, can transmit an analog measurement signal generated by means of a measuring device to the receiver apparatus, with the measurement signal being evaluated and/or further processed by the receiver apparatus or by means connected to the receiver apparatus.

For the transmission of the analog measurement signals, sliding contacts are used in transmission systems of the initially named kind which can be made as slip rings with transmitter devices rotating with respect to the receiver apparatus. It is disadvantageous with transmission systems of this kind, however, that the sliding contacts are abraded by wear such that reliability problems can occur, in particular with a long period of use. This is in particular the case with high-speed processing machines which can have parts which rotate in operation at a speed of revolution of currently up to 10,000 r.p.m.

### SUMMARY OF THE PRESENT INVENTION

It is the underlying object of the invention to further develop a system and a method of the initially named kind such that a reliable transmission of analog measurement signals generated by means of a measuring device is made possible and in particular the energy supply of the transmitter apparatus and/or of the measuring device is simultaneously ensured with a transmitter apparatus movable, in particular rotatably movable, relative to the receiver apparatus even with a long period of use and at high relative speeds.

This object is satisfied, on the one hand, by the features of the independent apparatus claim and in particular by a system for contact-free signal transmission and energy transmission comprising a transmitter apparatus for the transmission of a digital signal which includes at least one measurement signal generated by means of a measuring device, in particular a measurement signal digitized by means of an A/D converter unit of the transmitter apparatus, and a receiver apparatus for the reception of the transmitted digital signal, with the transmitter apparatus being movable, in particular rotatably movable, relative to the receiver apparatus and energy being able to be transmitted from the receiver apparatus to the transmitter apparatus for the energy supply of the transmitter apparatus and/or of the measuring device.

The object underlying the invention is also satisfied by the features of the independent method claim and in particular by a method for contact-free signal transmission and energy transmission between a transmitter apparatus and a receiver apparatus which are movable, in particular rotatably movable, with respect to one another, with a measurement signal being generated by means of a measuring device, the measurement signal in particular being digitized by means of an A/D converter unit of the of the transmitter apparatus, a digital signal including at least the measurement signal being transmitted by means of the transmitter apparatus, the transmitted digital signal being received by means of the receiver apparatus and energy being transmitted from the receiver apparatus to the transmitter apparatus for the energy supply of the transmitter apparatus and/or of the measuring device.

The invention is characterized in that the transmitter apparatus is made at least for signal transmission to the receiver apparatus and the receiver apparatus is made at least for energy transmission to the transmitter apparatus, with the transmitter apparatus being movable, in particular rotatably movable, relative to the receiver apparatus. A bidirectional transmission is, for example, hereby made possible, with the transmitter apparatus being made as a transmitter for signals and a receiver for energy and the receiver apparatus being made as a transmitter for energy and a receiver for signals. The direction implied by the terms “transmitter apparatus” and “receiver apparatus” is meant here with respect to the signal to be transmitted and not with respect to the energy. The signal transmission and the energy transmission are then each realized as a simplex transmission. In accordance with the invention, it is furthermore possible for the signal transmission and/or the energy transmission to be realized as a duplex transmission. Provision can in particular be provided for the receiver apparatus to be additionally designed for signal transmission to the transmitter apparatus.

The energy transmitted from the receiver apparatus to the transmitter apparatus is used for the energy supply of the transmitter apparatus and/or of the measuring device, with the measuring device being connectable to the transmitter apparatus. The energy can in particular be transmitted from the receiver apparatus to the transmitter apparatus with a transmitter apparatus either moved relative to the receiver apparatus or unmoved relative to the receiver apparatus. The same also applies to the signal to be transmitted which is transmitted from the transmitter apparatus to the receiver apparatus.

In accordance with the invention, the signal transmission and the energy transmission each take place in a contact-free manner. The sliding contacts which tend toward wear can be omitted thanks to the contact-free transmission so that a reliable signal transmission is ensured. The system in accordance with the invention can in particular hereby be operated maintenance-free.

In accordance with the invention, an A/D converter unit is in particular provided which digitizes the analog measurement signal when a measuring device is used which generates analog measurement signals. In accordance with the invention, however, a measuring device can also be used which generates a digital signal. The measurement signal can in particular be detected with high precision. The digital signal can be transmitted by means of the transmitter apparatus, which in particular includes the A/D converter unit, to the receiver apparatus, which receives the digital signal.

The transmitted digital signal includes at least the measurement signal. The transmitted signal can include individual signals already present in digital form in addition to the measurement signal, for example, with the measurement signal and the individual digital signals being transmitted to the receiver apparatus as a common digital signal. For error recognition, a protocol is preferably used for the controlled transmission of the digital signal so that it is possible to recognize system errors as soon as possible and to report them to the evaluation means and/or further processing means connected to the receiver apparatus of the system in accordance with the invention. The system in accordance with the invention can also be designed for the exclusive transmission of signals other than measurement signals.

In accordance with the invention, it is thus possible to transmit energy from a receiver apparatus to a transmitter apparatus, in particular a rotating transmitter apparatus, moved relative to the receiver apparatus, to detect a measurement signal with high precision by means of the measuring device, to transmit digitally fast and reliably to the receiver apparatus by means of the transmitter apparatus and, optionally, to reanalogize, as will be explained in more detail at a later point, with the digitizing, the signal transmission and the reanalogizing being able to take place in real time with a delay of less than 10 μs.

The invention in this process combines components of different technical areas in a unique manner: contact-free energy transmission, in particular from the technical area of power electronics, fast and precise detection and/or preparation of the measurement signal, in particular from the technical area of analog and digital engineering, and fast and reliable signal transmission, in particular from the technical area of radio frequency engineering.

Advantageous embodiments of the invention are recited in the dependent claims, in the description and in the drawing.

Furthermore, it is proposed in accordance with the invention for the measuring device and/or the transmitter apparatus to be attachable to a rotating object, in particular to a spindle or a shaft. The measuring device can, for example, be a length measuring system or an angle measuring system. The measurement signal is generated by means of the measuring device on the rotating object and is in particular digitized there by means of the transmitter apparatus. The rotating object can in particular be a fast-rotating part of a high-speed processing machine. The transmitter apparatus is preferably made as a rotor and the receiver apparatus as a stator. Generally, however, all applications are conceivable in which signals and energy should be transmitted between devices moved relative to one another, in particular for measured value transmission.

The transmitter can include one or more of the following elements for the preparation of the measurement signal, for the parallel/serial conversion of the digital signal to be transmitted, for the modulation of a carrier frequency with the digital signal and/or for the transmission of the digital signal in particular modulated onto a carrier frequency: a signal preparation unit, a parallel/serial converter unit, a modulation unit and a transmitter unit.

The receiver apparatus can include one or more of the following elements for the reception of the digital signal in particular modulated to a carrier frequency, for the demodulation of a carrier frequency modulated with the digital signal or for the reconstruction of the digital signal, and/or for the serial/parallel conversion of the digital signal: a receiver unit or antenna unit, a demodulation unit, a pulse preparation unit, a synchronization unit and a serial/parallel converter unit.

If required for the signal evaluation and/ for the further signal processing, the receiver apparatus can include a D/A converter unit for the analogizing of at least part of the digital signal and/or a signal preparation unit and/or a level generation unit. In particular with an analog measurement signal, the part of the digital signal including the digitized measurement signal can be reanalogized by means of the D/A converter unit. This is in particular of advantage when evaluation processing means and/or further processing means are used which are connected to the receiver apparatus of the system in accordance with the invention, are known from the prior art and are based on an analog measurement signal. The received signal can, however, generally also be evaluated and/or further processed in digital form.

Furthermore, in accordance with the invention, the transmitter apparatus or a part thereof and/or the receiver unit or a part thereof can be made rotatably invariant with respect to an axis of rotation of the system such that the signal transmission and/or the energy transmission is independent of the angular position of a transmitter apparatus attached to a rotating object relative to the receiver apparatus. The axis of rotation of the system then corresponds to the axis of rotation of the rotating object to which the transmitter apparatus is attached.

In accordance with an advantageous embodiment of the invention, the digital signal is modulated onto an RF carrier frequency for the signal transmission. The carrier frequency, i.e. a permitted frequency with a bandwidth required for the transmission, is clocked with the data rate and transmitted to the receiver apparatus. The carrier frequency can be arranged, for example, in the GHz range and/or a plurality of channels can be provided.

It is particularly advantageous for the digital signal to be transferable capacitively from the transmitter apparatus to the receiver apparatus. The transmitter apparatus and the receiver apparatus preferably each have an electrode for the capacitive signal transmission. The electrodes can in particular each be made rotatably invariant with respect to an axis of rotation of a system, in particular circular. Two electrodes made as circular capacitor plates can, for example, be provided. Amplitude errors and/or phase errors in the signal transmission from a transmitter apparatus rotating relative to the receiver apparatus to the receiver apparatus can be avoided by the rotational invariance of the electrodes with respect to an axis of rotation of the system such as is explained above.

Alternatively, the digital signal can be transmissible optically from the transmitter apparatus to the receiver apparatus. The transmitter apparatus can include an optical transmitter unit, in particular a transmitter diode, and the receiver apparatus can include an optical receiver unit, in particular a receiver diode arrangement, for the optical signal transmission. The receiver diode arrangement can also only include an individual receiver diode. The optical transmitter unit and the optical receiver unit can in particular be made for signal transmission in the infrared range, in the ultraviolet range or in the visible range. When optical filters are used, which can be components of the receiver apparatus, different optical frequency ranges can be utilized.

In accordance with a particularly preferred embodiment of the invention, the optical transmitter or receiver unit is made centrally with respect to an axis of rotation of the system. With a central arrangement with respect to an axis of rotation of the system as explained above, the transmission of the digital signal can be designed in a particularly simple manner irrespective of the angular position of the transmitter apparatus relative to the receiver apparatus.

The receiver apparatus preferably includes a power oscillator or a clock/frequency generator for the energy generation. The energy is not generated using a dynamo principle, so that the energy generated by the power oscillator or clock/frequency generator can also be transmitted from the receiver apparatus to the transmitter apparatus when the transmitter apparatus is stationary relative to the receiver apparatus.

In accordance with a special embodiment of the invention, the energy can be transmitted inductively from the receiver apparatus to the transmitter apparatus. The receiver apparatus and the transmitter apparatus can each have a coil system, in particular a ferrite-assisted coil system, for inductive energy transmission. The coil system of the transmitter apparatus is preferably made as part of a serial resonant circuit tuned to an operating frequency of the coil system of the receiver apparatus so that large currents can be taken from the coil system of the transmitter apparatus. Surprisingly easily reproducible transmission values can be achieved when wind data, mechanical spacings and component tolerances are observed.

The coil systems of the receiver apparatus and of the transmitter apparatus preferably have a spacing of some millimeters or smaller. A high efficiency of the energy transmission, in particular of more than 60%, can hereby be achieved. Basically, however, different, and in particular larger, spacings are also possible.

Alternatively, the energy can be optically transmissible from the receiver apparatus to the transmitter apparatus. The receiver apparatus can include a light transmitter unit and the transmitter apparatus can include at least one photovoltaic element, in particular a solar cell, for optical energy transmission. The photovoltaic element or elements can in particular be made rotatably invariantly with respect to an axis of rotation of the system. The energy which can be taken from the photovoltaic element or elements is independent of the angular position of the transmitter apparatus relative to the receiver apparatus due to the rotatable invariance of the photovoltaic element or elements with respect to an axis of rotation of the system as explained above. The optical energy transmission is furthermore not influenceable by electrical and/or magnetic interference fields, can itself not generate any interference fields and can also be used at larger spacings from one another.

### BRIEF DESCRIPTION OF THE DRAWING

The invention will be described in the following by way of example with reference to the drawing. There are shown:

FIG. 1 a simplified block diagram of elements of a transmitter apparatus of a system in accordance with the invention provided for signal transmission;

FIG. 2 a simplified block diagram of elements of a receiver apparatus of a system in accordance with the invention provided for signal transmission;

FIG. 3 a perspective view of a constructive embodiment of a system in accordance with the invention;

FIG. 4 a front view of the system in accordance with the invention of FIG. 3;

FIG. 5 a longitudinal section through the system in accordance with the invention of FIG. 4 along the line A-A; and

FIG. 6 a longitudinal section through the system in accordance with the invention of FIG. 4 along the line B-B.

### DETAILED DESCRIPTION OF THE INVENTION

In the transmitter apparatus 11 shown in FIG. 1 for contact-free signal transmission, an analog measurement signal Uₛᵢₙ, U_{cos}, which represents a length or an angle, for example, and is generated by a measuring device (not shown) is applied to a signal preparation unit 13 for the preparation of the analog measurement signal Uₛᵢₙ; U_{cos}. In addition to the analog measurement signal Uₛᵢₙ, U_{cos}, three individual digital signals Rᵢ, A, B are applied to the signal preparation unit 13 and are likewise prepared by the signal preparation unit 13.

The prepared analog signal is forwarded by the signal preparation unit 13 to an A/D converter unit 15 to be digitized there, with the digitized signal being output in parallel form by the A/D converter unit 15. The A/D converter unit 15 can, for example, have an output rate in the range from 333 kS/s up to 500 kS/s and a resolution of 12 bits. The individual digital signals prepared by the signal preparation unit 13 are read in by a read-in unit 17.

The transmitter apparatus 11 of the system in accordance with the invention furthermore includes a parallel/serial converter unit 19 connected to the A/D converter unit 15 and the read-in unit 17 for the parallel/serial conversion of the digitized signal present in parallel form and of the individual digital signals present parallel thereto. A digital signal including the digitized signal and the individual digital signals is output in serial form by the parallel/serial converter unit 19. To ensure a controlled signal transmission and/or to allow system errors to be recognized as soon as possible, a protocol recognizing errors is used.

The digital signal output by the parallel/serial converter unit 19 in serial form is modulated onto an RF carrier frequency by means of a modulation unit (not shown) connected to the parallel/serial converter unit 19 for the encoding of the digital signal to be transmitted, said RF carrier frequency amounting, for example, to 2.4 GHz. The modulation unit is connected to a transmitter unit 23 for the transmission of the digital signal.

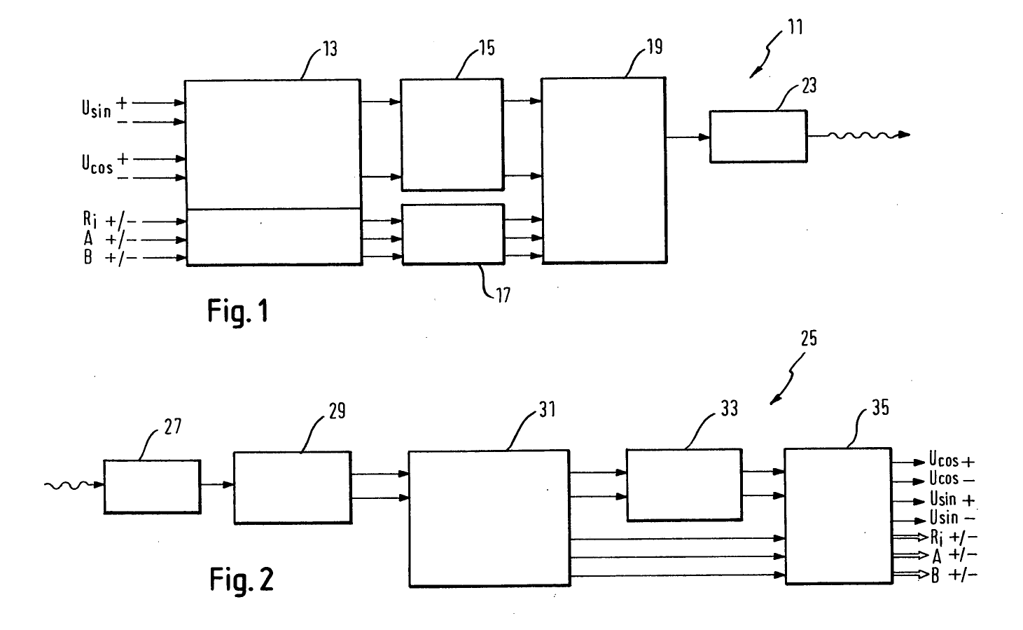

The digital signal generated by the transmitter apparatus 11 shown in FIG. 1 is transmitted in contact-free manner via the transmitter unit 23 to a receiver unit 27 of a receiver apparatus 25 of the system in accordance with the invention shown in FIG. 2. A demodulation unit 29 interposed downstream of the receiver unit 27 is provided for the reconstruction of the digital signal from the carrier frequency modulated with the digital signal.

The reconstructed digital signal, which is initially present in serial form after the reconstruction by the demodulation unit 29, is transmitted by the demodulation unit 29 to a serial/parallel converter unit 31 for serial/parallel conversion. The serial/parallel converter unit 31 moreover has a section which is made as a protocol state machine. The digital signal is output in parallel form by the serial/digital converter unit 31, with the output digital signal corresponding to the signal previously input into the parallel/serial converter unit 19 of the transmitter unit 11 or including the digitized signal present in parallel form and the individual digital signals.

The part of the digital signal output by the serial/parallel converter unit 31 including the digitized signal is reanalogized by means of a D/A converter unit 33.

A signal preparation unit 35 is provided for the signal preparation and for the level conversion of the reanalogized signal and of the individual digital signals. The analog measurement signal Uₛᵢₙ, U_{cos} and the individual digital signals R_{,i}A, B are thus present at the output of the signal preparation unit 35 in the form previously output by the measurement device and input into the signal preparation unit 13 of the transmitter unit 11 so that evaluation means and/or further processing means known from the prior art and designed only for the processing of an analog measurement signal, can be connected to the system in accordance with the invention.

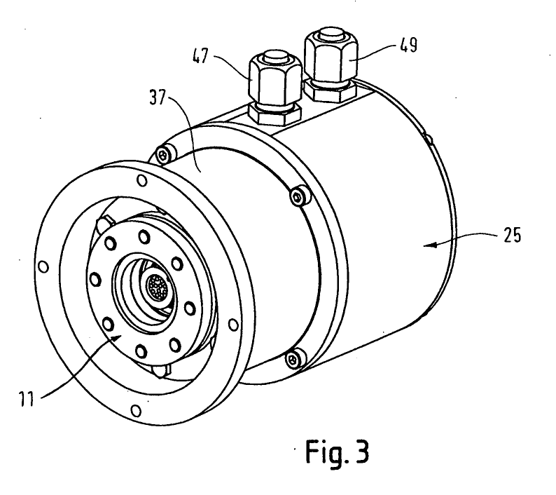

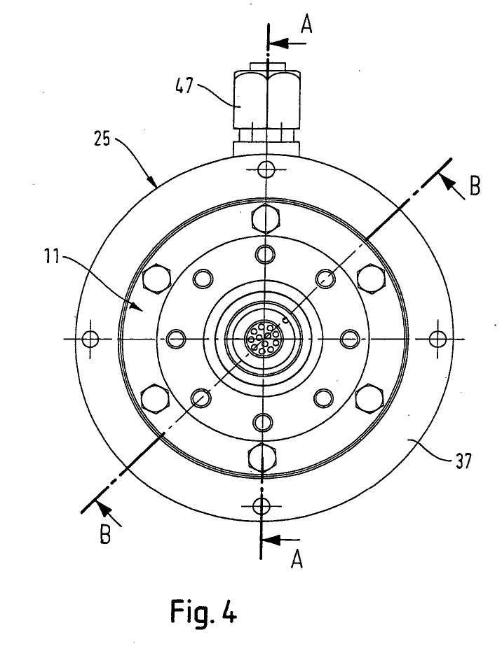

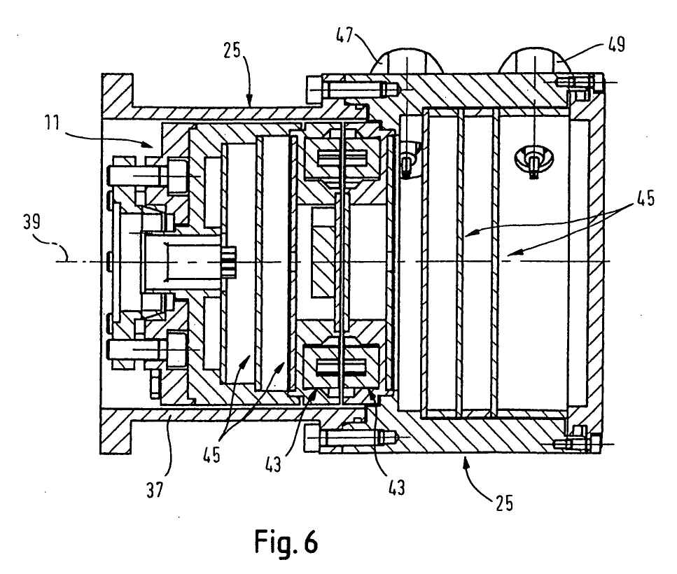

FIGS. 3 to 6 show a design embodiment of a system in accordance with the invention for contact-free signal transmission and energy transmission comprising a transmitter apparatus 11 for the transmission of a digital signal and a receiver apparatus 25 for the reception of the transmitted digital signal, with energy being able to be transmitted in the opposite direction, i.e. from the receiver apparatus 25 to the transmitter apparatus 11.

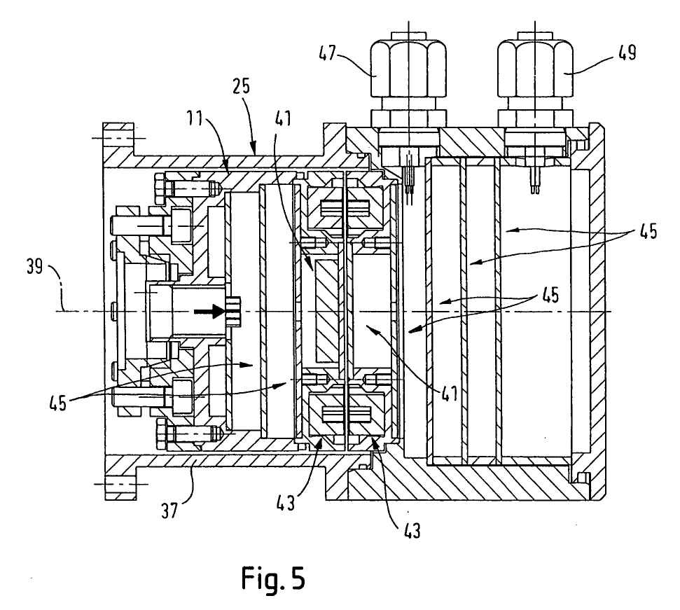

The transmitter apparatus 11 made as a rotor is rotatable inside a cylindrical stator flange 37 of the receiver apparatus 25 made as a stator about an axis of rotation 39 also termed an axis of rotation of the system. For this purpose, the transmitter apparatus 11 and a measuring device (not shown) are attached to a shaft (not shown) so that the transmitter apparatus 11 is rotatably movable relative to the receiver apparatus 25. The measuring device is made for the generation of an analog measurement signal representing, for example, a length or an angle. The analog measurement signal is transmitted from the measuring device to the transmitter apparatus 11, as illustrated by means of an arrow in FIG. 5.

The transmitter apparatus 11 and the receiver apparatus 25 each have an electrode in particular made as a circular capacitor plate 41 which lie opposite one another and whose centers coincide with the axis of rotation 39 so that the capacitor plates 41 are made rotationally invariant with respect to the axis of rotation 39 for the capacitive signal transmission from the transmitter apparatus 11 to the receiver apparatus 25. The capacitor plates 41 in this process correspond to the transmitter unit 23 and to the receiver unit 27 from FIGS. 1 and 2.

The transmitter apparatus 11 and the receiver apparatus 25 furthermore each include a ferrite-assisted coil system 43 which are provided for inductive energy transmission from the receiver apparatus 25 to the transmitter apparatus 11 for the energy supply of the transmitter apparatus 11 and of the measuring device, with the coil systems 43 having a mutual spacing of 0.8 mm. The coil systems 43 are each made as a circular ring and thus likewise rotationally invariant with respect to the axis of rotation 39. The electrodes 41 of the transmitter apparatus 11 and of the receiver apparatus 25 are each arranged at the center of the coil system 43 in particular made as a circular ring.

The transmitter apparatus 11 and the receiver apparatus 25 furthermore each have a plurality of boards 45 which are arranged parallel to one another and in planes extending perpendicular to the axis of rotation 39. The boards 45 are fitted with elements, in particular electronic circuits, which are provided for signal processing and energy generation. The elements attached to the boards 45 include a power oscillator (not shown) for energy generation and the elements shown in FIGS. 1 and 2, with the control of the A/D converter unit and the D/A converter unit each being made as a freely programmable logic circuit, in particular as FPGA's and CPLD's. These logic circuits in particular also process the parallel/serial conversion in the transmitter apparatus 11 and the synchronization and the serial/parallel conversion in the receiver apparatus 25.

The power oscillator, whose alternating voltage acts on the coil system 43 of the receiver apparatus 25, with energy being transmitted inductively to the coil system 43 of the transmitter apparatus 11, can, for example, have an operating frequency of 100 kHz and an output power of 10 W. The coil system 43 of the transmitter apparatus 11 is part of a serial resonant circuit (not shown) of the transmitter apparatus 11 which is tuned to the operating frequency of the coil system 43 of the receiver apparatus 25 or of the power oscillator to ensure an efficiency of the energy transmission which is as high as possible. The currents taken from the coil system 43 of the transmitter apparatus 11 are used for the current supply of the elements shown in FIG. 2 and of the measuring device.

The receiver apparatus 25 has an onboard voltage connection 47, which is provided for connection to an external voltage source, for the voltage supply of the receiver apparatus 25, in particular of the power oscillator and of the elements shown in FIG. 1. The receiver apparatus 25 furthermore has a signal connection 49 which is made as a signal output for the outputting of the signals to an external evaluation unit and/or further processing unit (not shown).

The system in accordance with the invention makes it possible in an advantageous manner to read out analog measurement signals, in particular measured on rotating parts, with extremely high precision and speed, to transmit them digitally and in a contact-free manner to a receiver apparatus 25, to reconstruct them and to provide them to the receiver apparatus 25 again in analog form, with energy being transmissible likewise in a contact-free manner from the receiver apparatus 25 to the transmitter apparatus 11.

1. A system for contact-free signal transmission and energy transmission comprising
a transmitter apparatus (11) for the transmission of a digital signal which includes at least one measurement signal generated by means of a measuring device, in particular a measurement signal digitized by means of an AID converter unit (15) of the transmitter apparatus (11); and
a receiver apparatus (25) for the reception of the transmitted digital signal,
wherein
the transmitter apparatus (11) is movable, in particular rotatably movable, relative to the receiver apparatus (25); and
energy can be transmitted from the receiver apparatus (25) to the transmitter apparatus (11) for the energy supply of the transmitter apparatus (11) and/or of the measuring device.

2. A system in accordance with claim 1, characterized in that the measuring device and/or the transmitter apparatus (11) is attachable to a rotating object, in particular to a spindle or a shaft.

3. A system in accordance with claim 1, characterized in that the transmitter apparatus (11) includes one or more of the following elements: a signal preparation unit (13), a parallel/serial converter unit (19), a modulation unit and a transmitter unit (23).

4. A system in accordance with claim 1, characterized in that the receiver apparatus (25) includes one or more of the following elements: a receiver unit (27), a demodulation unit (29) and a serial/parallel converter unit (31).

5. A system in accordance with claim 1, characterized in that the receiver apparatus (25) includes a D/A converter unit (33) for the analogizing of at least part of the digital signal and/or a signal preparation unit (35).

6. A system in accordance with claim 1, characterized in that the transmitter apparatus (11) or a part (41, 43) thereof and/or the receiver apparatus (25) or a part (41, 43) thereof is rotatably invariant with respect to an axis of rotation (39) of the system.

7. A system in accordance with claim 1, characterized in that the digital signal is modulated onto an RF carrier frequency for signal transmission.

8. A system in accordance with claim 1, characterized in that the digital signal can be transmitted capacitively from the transmitter apparatus (11) to the receiver apparatus (25).

9. A system in accordance with claim 8, characterized in that the transmitter apparatus (11) and the receiver apparatus (25) each have an electrode (41) for capacitive signal transmission.

10. A system in accordance with claim 9, characterized in that the electrodes (41) are each made rotatably invariant with respect to an axis of rotation (39) of a system, in particular circular.

11. A system in accordance with claim 1, characterized in that the digital signal can be transmitted optically from the transmitter apparatus (11) to the receiver apparatus (25).

12. A system in accordance with claim 11, characterized in that the transmitter apparatus (11) includes an optical transmitter unit, in particular a transmitter diode, and the receiver unit (25) includes an optical receiver unit, in particular a receiver diode arrangement, for optical signal transmission.

13. A system in accordance with claim 12, characterized in that the optical transmitter unit and the optical receiver unit are made for signal transmission in the infrared range, in the ultraviolet range or in the visible range.

14. A system in accordance with claim 12, characterized in that the optical transmitter unit or receiver unit is made centrally with respect to an axis of rotation (39) of the system.

15. A system in accordance with claim 1, characterized in that the receiver apparatus (25) has a power oscillator or a clock/frequency generator for energy generation.

16. A system in accordance with claim 1, characterized in that the energy can be inductively transmitted from the receiver apparatus (25) to the transmitter apparatus (11).

17. A system in accordance with claim 16, characterized in that the receiver apparatus (25) and the transmitter apparatus (11) each have a coil system (43), in particular a ferrite-assisted coil system, for inductive energy transmission.

18. A system in accordance with claim 17, characterized in that the coil system (43) of the transmitter apparatus (11) is made as part of a serial resonant circuit tuned to an operating frequency of the coil system (43) of the receiver apparatus (25).

19. A system in accordance with claim 17, characterized in that the coil systems (43) of the receiver apparatus (25) and of the transmitter apparatus (11) have a spacing of some millimeters or a smaller spacing.

20. A system in accordance with claim 1, characterized in that the energy can be optically transmitted from the receiver apparatus (25) to the transmitter apparatus (11).

21. A system in accordance with claim 20, characterized in that the receiver apparatus (25) includes a light transmitter unit and the transmitter apparatus (11) includes at least one photovoltaic element, in particular a solar cell, for optical energy transmission.

22. A system in accordance with claim 21, characterized in that the photovoltaic element or elements are rotatably invariant with respect to an axis of rotation (39) of the system.

23. A method for the contact-free signal transmission and energy transmission between a transmitter apparatus (11) and a receiver apparatus (25) which are movable, in particular rotatably movable, relative to one another, wherein
a measurement signal is generated by means of a measuring device;
the measurement signal is in particular digitized by means of an A/D converter unit (15) of the transmitter unit (11);
a digital signal, which includes at least the measurement signal, is transmitted by means of the transmitter apparatus (11);
the transmitted digital signal is received by means of the receiver apparatus (25); and
energy is transmitted from the receiver apparatus (25) to the transmitter apparatus (11) for the energy supply of the transmitter apparatus (11) and/or of the measuring device.

24. A method in accordance with claim 23, characterized in that the measuring device and/or the transmitter apparatus (11) is attachable to a rotating object, in particular to a spindle or a shaft.

25. A method in accordance with claim 23, characterized in that at least a part of the digital signal is analogized by means of a D/A converter unit (33) of the receiver apparatus (25).

26. A method in accordance with claim 23, characterized in that the digital signal is modulated onto an RF carrier frequency for signal transmission.

27. A method in accordance with claim 23, characterized in that the digital signal is transmitted capacitively from the transmitter apparatus (11) to the receiver apparatus (25).

28. A method in accordance with claim 23, characterized in that the digital signal is transmitted optically from the transmitter apparatus (11) to the receiver apparatus (25).

29. A method in accordance with claim 28, characterized in that the digital signal is transmitted in the infrared range, in the ultraviolet range or in the visible range.

30. A method in accordance with claim 23, characterized in that the energy is inductively transmitted from the receiver apparatus (25) to the transmitter apparatus (11).

31. A method in accordance with claim 30, characterized in that the transmitter apparatus (11) is tuned to an operating frequency of the receiver apparatus (25).

32. A method in accordance with claim 23, characterized in that the energy is optically transmitted from the receiver apparatus (25) to the transmitter apparatus (11).
